(19) United States
(12) Patent Application Publication
(10) Pub. No.: US 2026/0309930 A1
(43) Pub. Date: Oct. 8, 2026

(54) OPTICAL CONNECTOR AND OPTICAL CONNECTION STRUCTURE

(71) Applicants: SUMITOMO ELECTRIC OPTIFRONTIER CO., LTD., Yokohama-shi, Kanagawa (JP); SUMITOMO ELECTRIC INDUSTRIES LTD., Osaka-shi, Osaka (JP)

(72) Inventors: Masahiro SHIBATA, Kanagawa (JP); Takayuki SHIMAZU, Osaka (JP)

(73) Assignees: SUMITOMO ELECTRIC OPTIFRONTIER CO., LTD., Yokohama-shi, Kanagawa (JP); SUMITOMO ELECTRIC INDUSTRIES LTD., Osaka-shi, Osaka (JP)

(21) Appl. No.: 19/491,449

(22) PCT Filed: Jul. 5, 2024
(86) PCT No.: PCT/JP2024/024505

§ 371 Date: Dec. 9, 2025

(30) Foreign Application Priority Data
Jul. 18, 2023 (JP) 2023-116795

(51) Int. Cl. G02B 6/38; G02B 6/40

(52) U.S. Cl. CPC G02B 6/3885; G02B 6/3825; G02B 6/387; G02B 6/3882; G02B 6/403

(57) ABSTRACT

An optical connector, comprising: a plurality of optical fibers extending rearward along a first direction; a ferrule that holds front end portions of the plurality of optical fibers; a grip portion provided on an outer periphery of the plurality of optical fibers and disposed rearward of the ferrule; and a connecting portion disposed between the ferrule and the grip portion and connecting the ferrule and the grip portion. The ferrule has a front end surface facing a mating ferrule in the first direction, a rear end surface facing away from the front end surface, a first side surface and a second side surface that intersect a second direction, which is a width direction of the ferrule, while facing away from each other with the plurality of optical fibers interposed between the first side surface and the second side surface.

### TECHNICAL FIELD

The present disclosure relates to an optical connector and an optical connection structure. Priority is claimed on Japanese Patent Application No. 2023-116795, filed on Jul. 18, 2023, the entire content of which is incorporated herein by reference.

### BACKGROUND ART

Patent Literature 1 discloses a technology related to an interconnection system including a plurality of fiber cables for optical connection and a method for wiring the fiber cables. This system includes a connector housing that accommodates an optical connector in an optical adapter, and a ferrule provided in the optical connector. The ferrule is provided at a termination portion of one or a plurality of optical fibers. The optical connector is formed by the connector housing, and the optical connector is attached inside the optical adapter.

### CITATION LIST

### Patent Literature

Patent Literature 1: U.S. Pat. No. 11,474,307
Patent Literature 2: United States Patent Application Publication No. 2019-0187383
Patent Literature 3: United States Patent Application Publication No. 2023-0003949

### SUMMARY OF INVENTION

An optical connector according to one embodiment of the present disclosure includes a plurality of optical fibers extending rearward along a first direction; a ferrule that holds front end portions of the plurality of optical fibers; a grip portion provided on an outer periphery of the plurality of optical fibers and disposed rearward of the ferrule; and a connecting portion disposed between the ferrule and the grip portion and connecting the ferrule and the grip portion. The ferrule has a front end surface facing a mating ferrule in the first direction, a rear end surface facing away from the front end surface, a first side surface and a second side surface that intersect a second direction, which is a width direction of the ferrule, while facing away from each other with the plurality of optical fibers interposed between the first side surface and the second side surface, and that connect the front end surface and the rear end surface, and a first main surface and a second main surface that intersect a third direction, which is a thickness direction of the ferrule, while facing away from each other with the plurality of optical fibers interposed between the first main surface and the second main surface, and that connect the front end surface and the rear end surface. The connecting portion includes a first engaging portion that engages with the ferrule on the first main surface, and a second engaging portion that engages with the ferrule on the second main surface, and the ferrule is fixed to the connecting portion by the first engaging portion and the second engaging portion. An entirety of the first side surface and the second side surface is exposed.

### BRIEF DESCRIPTION OF DRAWINGS

FIG. 1 is a perspective view showing a configuration of an optical connection structure according to one embodiment of the present disclosure.

FIG. 2 is an exploded perspective view of the optical connection structure.

FIG. 3 is a perspective view showing the manner in which a sub-adapter is fitted into an opening portion of an optical adapter.

FIG. 4 is a perspective view showing the manner in which an optical connector is pulled out from the optical adapter, together with the sub-adapter.

FIG. 5 is a perspective view showing the appearance of the optical connector according to one embodiment.

FIG. 6 is an exploded perspective view of the optical connector.

FIG. 7 is a side view of the optical connector.

FIG. 8 is a perspective view showing a state where a connecting portion is attached to a ferrule.

FIG. 9 is a side view showing a protective tube having a cylindrical shape that is attached to a tip of an optical cable.

FIG. 10 is a front view of the optical connector when viewed in an x-direction.

FIG. 11 is a perspective view showing an optical connector according to a first modification, and shows a state before a grip portion is attached to a connecting portion.

FIG. 12 is a perspective view showing an optical connector according to a second modification.

FIG. 13 is a perspective view showing the appearance of a cap.

### DESCRIPTION OF EMBODIMENTS

### Technical Problem

An optical connector including a ferrule that holds a plurality of optical fibers may be accommodated, for example, in a protective tube having a cylindrical shape that is attached to the tip of an optical cable. For the sake of miniaturization, in recent years, the inner diameter of the protective tube has become smaller. When the width of the optical connector does not have sufficient clearance for the inner diameter of the protective tube, it is difficult to accommodate the optical connector in the protective tube. Reducing the width of the optical connector and miniaturizing the optical connector present a challenge.

### Advantageous Effects of Present Disclosure

According to the present disclosure, it is possible to provide the optical connector that can be miniaturized by reducing the width, and the optical connection structure suitable for the optical connector.

### Description of Embodiment of Present Disclosure

First, the contents of an embodiment of the present disclosure will be listed and described.
[1] An optical connector according to one embodiment of the present disclosure includes a plurality of optical fibers extending rearward along a first direction; a ferrule that holds front end portions of the plurality of optical fibers; a grip portion provided on an outer periphery of the plurality of optical fibers and disposed rearward of the ferrule; and a connecting portion disposed between the ferrule and the grip portion and connecting the ferrule and the grip portion. The ferrule has a front end surface facing a mating ferrule in the first direction, a rear end surface facing away from the front end surface, a first side surface and a second side surface that intersect a second direction, which is a width direction of the ferrule, while facing away from each other with the plurality of optical fibers interposed between the first side surface and the second side surface, and that connect the front end surface and the rear end surface, and a first main surface and a second main surface that intersect a third direction, which is a thickness direction of the ferrule, while facing away from each other with the plurality of optical fibers interposed between the first main surface and the second main surface, and that connect the front end surface and the rear end surface. The connecting portion includes a first engaging portion that engages with the ferrule on the first main surface, and a second engaging portion that engages with the ferrule on the second main surface, and the ferrule is fixed to the connecting portion by the first engaging portion and the second engaging portion. An entirety of the first side surface and the second side surface is exposed.

A spacing between the first side surface and the second side surface defines a maximum width of the ferrule. In a typical optical connector, at least a part of each of the first side surface and the second side surface of the ferrule is covered by a housing. Therefore, portions of the housing that are provided on the first side surface and the second side surface define a maximum width of the optical connector, and the maximum width of the optical connector is greater than a maximum width of the ferrule. In contrast, in the optical connector described above, the first engaging portion engages with the ferrule on the first main surface of the ferrule, and the second engaging portion engages with the ferrule on the second main surface of the ferrule, so that the ferrule is fixed to the grip portion via the connecting portion. Then, the entirety of the first side surface and the second side surface is exposed. Accordingly, the first side surface and the second side surface are not covered by a housing or the like, and the spacing between the first side surface and the second side surface, that is, the maximum width of the ferrule can be set to the maximum width of the optical connector. Therefore, the width of the optical connector can be reduced, and the optical connector can be miniaturized.
[2] The optical connector according to [1] above may further include a guide pin. The ferrule may further have first guide pin holes aligned in the second direction and penetrating through the ferrule along the first direction. The grip portion may have a second guide pin hole communicating with the first guide pin hole. The guide pin may be inserted so as to extend from the first guide pin hole to the second guide pin hole. In this case, the connection between the ferrule and the grip portion is further strengthened through the guide pin.
[3] The optical connector according to [1] above may further include a guide pin. The ferrule may further have first guide pin holes aligned in the second direction and penetrating through the ferrule along the first direction. The guide pin may be inserted into the first guide pin hole, and the connecting portion may hold the guide pin. In this way, the connecting portion may serve as a portion for holding the guide pin, that is, a guide pin keeper. In this case, compared to when a guide pin keeper is provided separately, the number of components can be reduced.
[4] The optical connector according to any one of [1] to [3] above may further include a guide pin; and a cap that covers the front end surface of the ferrule. The ferrule may further have first guide pin holes aligned in the second direction in the front end surface, and the guide pin may be inserted into the first guide pin hole. The cap may have a third guide pin hole which communicates with the first guide pin hole and into which the guide pin is inserted, and the cap may be fixed to the ferrule by inserting the guide pin into the third guide pin hole. In this case, since the cap is supported by the guide pin, a portion that covers the first side surface, the second side surface, the first main surface, and the second main surface can be made thinner compared to when the cap is supported only by the first side surface, the second side surface, the first main surface, and the second main surface of the ferrule. Therefore, even in a state where the cap is installed, the optical connector can be miniaturized by reducing the width of the optical connector.
[5] In the optical connector according to any one of [1] to [4] above, the grip portion and the connecting portion may be configured to be contained within a circumscribed circle of the ferrule when viewed in the first direction. Accordingly, the width of the optical connector in any direction in a plane perpendicular to the first direction is equal to or less than the maximum width of the ferrule. Therefore, the optical connector is easily accommodated in a protective tube having a cylindrical shape.
[6] In the optical connector according to any one of [1] to [5] above, a member constituting the grip portion may be made of resin, and a member constituting the connecting portion may be made of metal. By using resin as the material of the member constituting the grip portion, the weight of the optical connector can be reduced. In addition, by using metal as the material of the member constituting the connecting portion, the strength of the connecting portion can be improved.
[7] In the optical connector according to any one of [1] to [6] above, the grip portion may have a third side surface and a fourth side surface that intersect the second direction while facing away from each other with the plurality of optical fibers interposed between the third side surface and the fourth side surface. The connecting portion may include a third engaging portion that engages with the grip portion on the third side surface, and a fourth engaging portion that engages with the grip portion on the fourth side surface, and the grip portion may be fixed to the connecting portion by the third engaging portion and the fourth engaging portion. In this case, in the connecting portion, a direction in which the first engaging portion and the second engaging portion are aligned (third direction) and a direction in which the third engaging portion and the fourth engaging portion are aligned (second direction) can be set different from each other. Therefore, the connecting portion can be easily formed, for example, by forming the connecting portion from a single metal sheet using sheet metal working.
[8] An optical connection structure according to one embodiment of the present disclosure includes the optical connector according to any one of [1] to [7] above; and a sub-adapter. The sub-adapter includes a latch portion that locks onto an optical adapter to detachably fix the sub-adapter to the optical adapter, and a fitting hole that is fitted to the optical connector. The optical connector is held by the sub-adapter by being fitted into the fitting hole of the sub-adapter. In the optical connection structure, when the optical connector is fitted to the sub-adapter, the optical connector is removed from a protective tube. Then, after the optical connector is fitted to the sub-adapter, the optical connector becomes integrated with the sub-adapter, and when the optical connector is removed from the optical adapter, the latch portion of the sub-adapter is released. According to such an optical connection structure, the optical connector can be detachably fixed to the optical adapter.

### DETAILS OF EMBODIMENT OF PRESENT DISCLOSURE

Specific examples of an optical connector and an optical connection structure of the present disclosure will be described below with reference to the drawings. The present invention is not limited to these examples, and is intended to include all modifications defined by the claims and within the spirit and scope of the equivalents of the claims. In the following description, the same elements in the description of the drawings are denoted by the same reference signs, and duplicate descriptions will be omitted. In each drawing, an xyz Cartesian coordinate system is shown as necessary. An x-direction corresponds to a first direction. A positive x-direction is the front, and a negative x-direction is the rear. A y-direction corresponds to a second direction. A z-direction corresponds to a third direction.

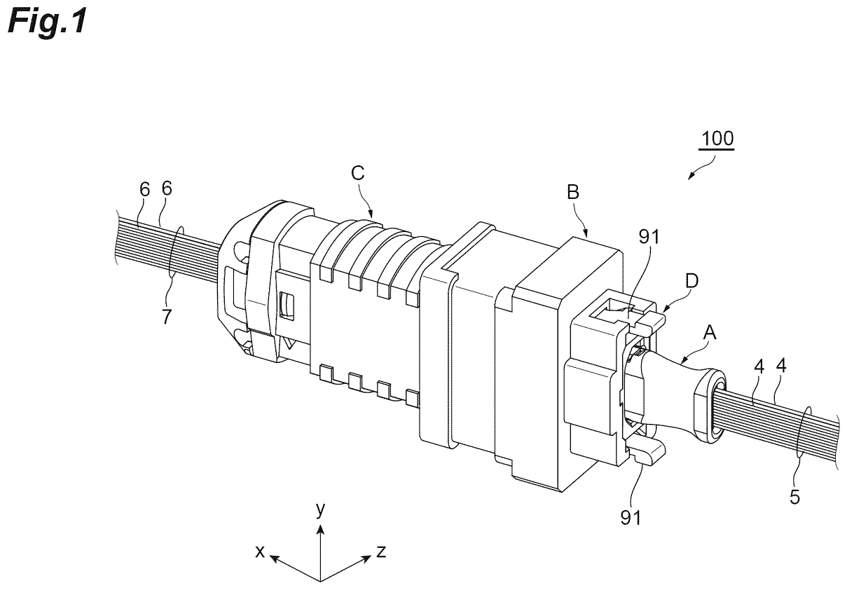

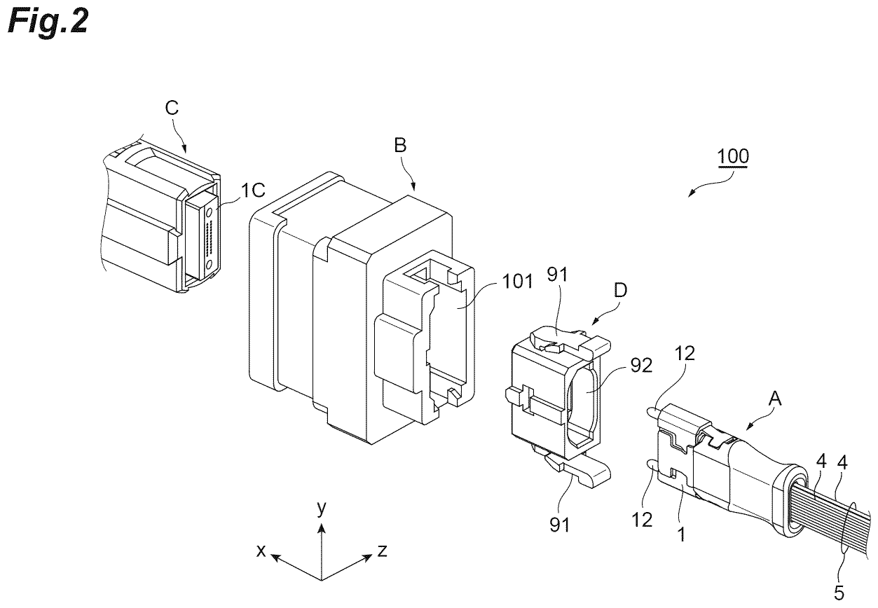

FIG. 1 is a perspective view showing a configuration of an optical connection structure 100 according to one embodiment of the present disclosure. FIG. 2 is an exploded perspective view of the optical connection structure 100. As shown in FIGS. 1 and 2, the optical connection structure 100 of the present embodiment includes an optical connector A, an optical adapter B, an optical connector C, and a sub-adapter D. The optical connector A includes a ferrule 1 and two guide pins 12. The ferrule 1 holds a front end portion of an optical fiber group 5. The optical fiber group 5 is composed of a plurality of optical fibers 4 extending rearward along the same direction (x-direction). The sub-adapter D has, for example, a rectangular tubular shape extending in the x-direction, and includes a pair of latch portions 91 and a fitting hole 92. The latch portions 91 are latch levers provided on both respective side surfaces of the sub-adapter D in the y-direction, and lock onto the optical adapter B to detachably fix the sub-adapter D to the optical adapter B. The fitting hole 92 penetrates through the sub-adapter D in the x-direction, and is fitted to the optical connector A. The optical connector A is held by the sub-adapter D by being fitted into the fitting hole 92 of the sub-adapter D.

The optical connector C is a connection mating optical connector, and is a conventional optical connector, for example, an MPO connector. The optical connector C includes a mating ferrule 1C. The mating ferrule 1C holds a front end portion of an optical fiber group 7. The optical fiber group 7 is composed of a plurality of optical fibers 6 extending forward along the same direction (x-direction), that is, rearward when viewed from the optical connector C.

The optical adapter B receives the sub-adapter D from one end in the x-direction, and receives the optical connector C from the other end in the x-direction. That is, the optical adapter B includes an opening portion 101 that is fitted to the sub-adapter D, and an opening portion (not shown) that is fitted to the optical connector C. Inside the optical adapter B, the ferrule 1 of the optical connector A faces the mating ferrule 1C of the optical connector C. In one example, the ferrule 1 abuts against the mating ferrule 1C. At this time, the two guide pins 12 are inserted into two respective guide pin holes formed in the mating ferrule 1C, so that the ferrule 1 and the mating ferrule 1C are positioned with respect to each other. Accordingly, the plurality of optical fibers 4 are optically coupled to the plurality of respective optical fibers 6.

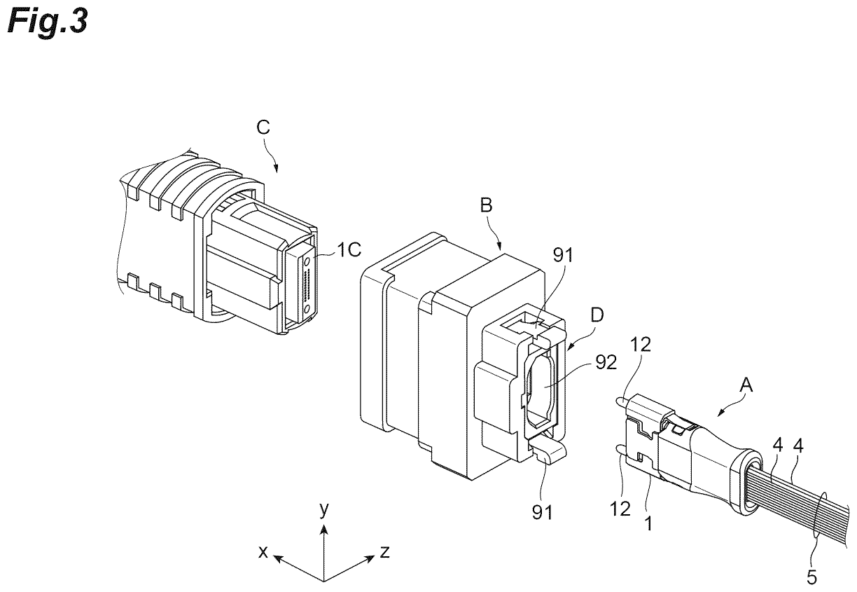

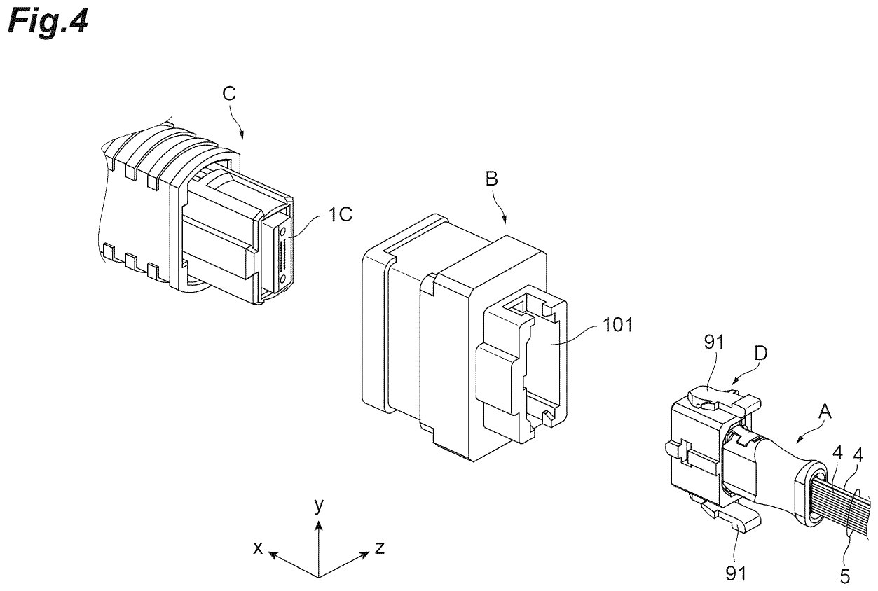

When the optical connection structure 100 is used, first, as shown in FIG. 3, the sub-adapter D is fitted into the opening portion 101 of the optical adapter B. Then, as shown in FIG. 1, the optical connector A is fitted into the fitting hole 92 of the sub-adapter D, and the optical connector C is fitted into the opening portion (not shown) of the optical adapter B. Accordingly, the plurality of optical fibers 4 are optically coupled to the plurality of optical fibers 6. Thereafter, when it is necessary to remove the optical connector A from the optical adapter B, as shown in FIG. 4, the optical connector A is pulled out from the optical adapter B, together with the sub-adapter D, by releasing the pair of latch portions 91. Thereafter, the optical connector A is attached to and detached from the optical adapter B by attaching and detaching the sub-adapter D to and from the optical adapter B.

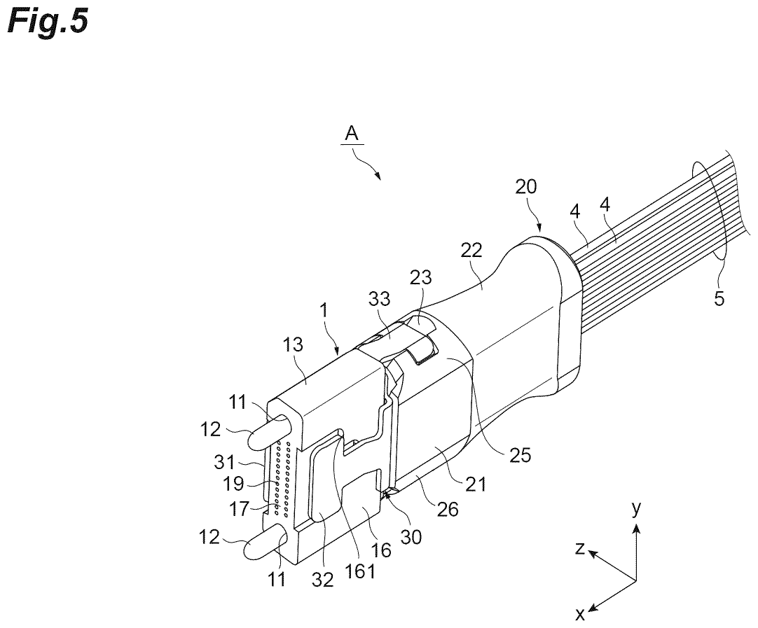

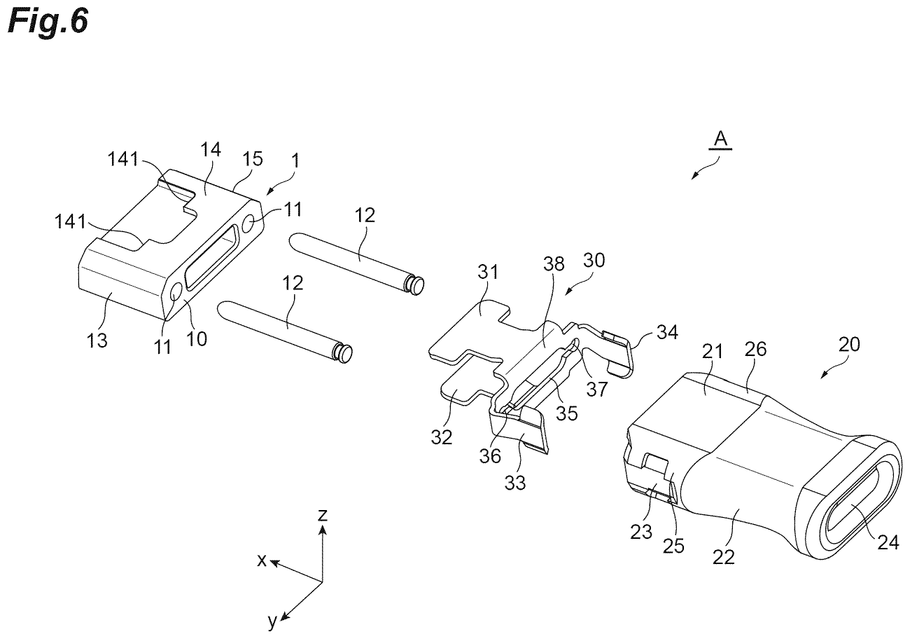

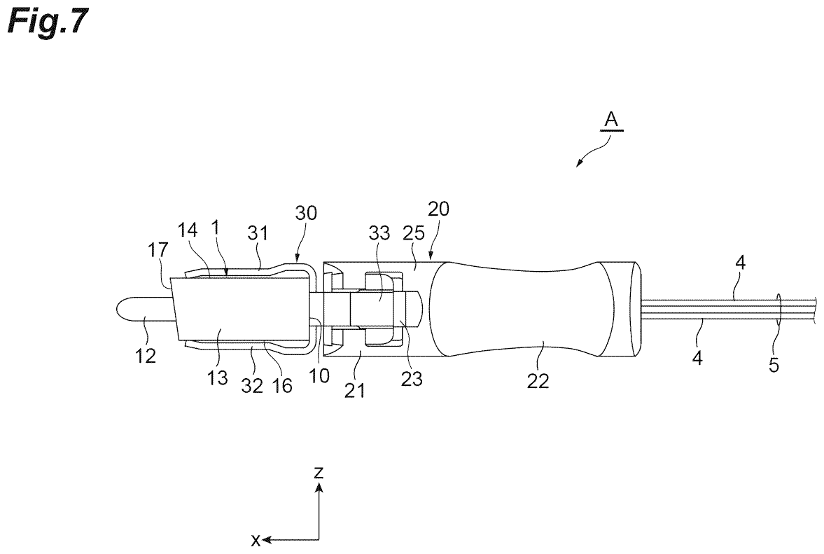

FIG. 5 is a perspective view showing the appearance of the optical connector A according to the present embodiment. FIG. 6 is an exploded perspective view of the optical connector A. FIG. 7 is a side view of the optical connector A. However, the illustration of the optical fiber group 5 is omitted in FIG. 6. The structure of the optical connector A will be described in detail with reference to FIGS. 5, 6 and 7.

The optical connector A includes a grip portion 20 and a connecting portion 30 in addition to the plurality of optical fibers 4 and the ferrule 1. The ferrule 1 is a so-called MT ferrule. The ferrule 1 has a substantially rectangular parallelepiped appearance. The shape of the ferrule 1 when viewed in the x-direction is a substantially rectangular shape. A plurality of fiber holes 19 into which the plurality of respective optical fibers 4 are inserted are provided inside the ferrule 1. The plurality of fiber holes 19 are formed in alignment in the y-direction and the z-direction (or only in the y-direction). The fiber holes 19 hold front end portions of the respective optical fibers 4. The material of the ferrule 1 is, for example, resin.

The ferrule 1 has a side surface 13 (first side surface); a main surface 14 (first main surface); a side surface 15 (second side surface); a main surface 16 (second main surface); a front end surface 17; a rear end surface 10; and two guide pin holes 11 (first guide pin holes). The ferrule 1 has the y-direction as a width direction and the z-direction as a thickness direction. That is, a dimension of the ferrule 1 in the y-direction is greater than a dimension of the ferrule 1 in the z-direction. The side surface 13 and the side surface 15 intersect the y-direction, and extend along the z-direction and the x-direction. The side surface 13 and the side surface 15 connect the front end surface 17 and the rear end surface 10. The side surface 13 and the side surface 15 face away from each other with the plurality of fiber holes 19 interposed therebetween. The side surface 13 and the side surface 15 are flat. The entirety of the side surface 13 and the side surface 15 is exposed to the outside of the optical connector A. In other words, the entirety of the side surface 13 and the side surface 15 is not covered by any member of the optical connector A. The main surface 14 and the main surface 16 intersect the z-direction, and extend along the x-direction and the y-direction. The main surface 14 and the main surface 16 face away from each other with the plurality of fiber holes 19 interposed therebetween. A pair of steps 141 aligned in the y-direction are provided on the main surface 14. A similar pair of steps 161 are also provided on the main surface 16.

The front end surface 17 is a flat surface facing the mating ferrule 1C in the x-direction, and intersects the x-direction. In one example, the front end surface 17 abuts against the mating ferrule 1C. The rear end surface 10 faces away from the front end surface 17, and intersects the x-direction. The two guide pin holes 11 are provided at both end portions of the front end surface 17 in the y-direction, and are aligned along the y-direction. The two guide pin holes 11 penetrate through the interior of the ferrule 1 from the front end surface 17 to the rear end surface 10 along the x-direction. The two guide pins 12 are aligned along the y-direction.

The two guide pins 12 are held by the two respective guide pin holes 11, and protrude forward from the front end surface 17. The two guide pins 12 have a cylindrical shape, and extend in the x-direction. The material of the two guide pins 12 is, for example, metal.

The grip portion 20 is provided on an outer periphery of the optical fiber group 5, and is disposed to face the rear end surface 10 at the rear of the ferrule 1. The grip portion 20 has a shape that is plane-symmetric with respect to an imaginary plane including a center line of the optical connector A and parallel to an xy plane. The grip portion 20 has a substantially elongated cylindrical shape, and has a through-hole 24 extending in the x-direction. The optical fiber group 5 is inserted into the through-hole 24. The grip portion 20 includes a front portion 21 and a rear portion 22. The front portion 21 is provided forward of the rear portion 22 in the x-direction. The through-hole 24 penetrates through the front portion 21 and the rear portion 22. The rear portion 22 is slightly constricted such that the rear portion 22 is easily gripped by the fingers of an operator.

The front portion 21 has a side surface 25 (third side surface) and a side surface 26 (fourth side surface). The side surface 25 and the side surface 26 intersect the y-direction, and face away from each other with the plurality of optical fibers 4 interposed therebetween. The side surface 25 and the side surface 26 are curved to protrude outward from the grip portion 20. The side surface 25 includes a recess 23. The recess 23 accommodates an engaging portion 33 of the connecting portion 30 to be described later to engage with the engaging portion 33. The side surface 26 also includes a recess (not shown) having a shape similar to that of the recess 23. The recess of the side surface 26 accommodates an engaging portion 34 of the connecting portion 30 to be described later to engage with the engaging portion 34. The grip portion 20 is composed of a single member. The material of the member constituting the grip portion 20 is, for example, resin.

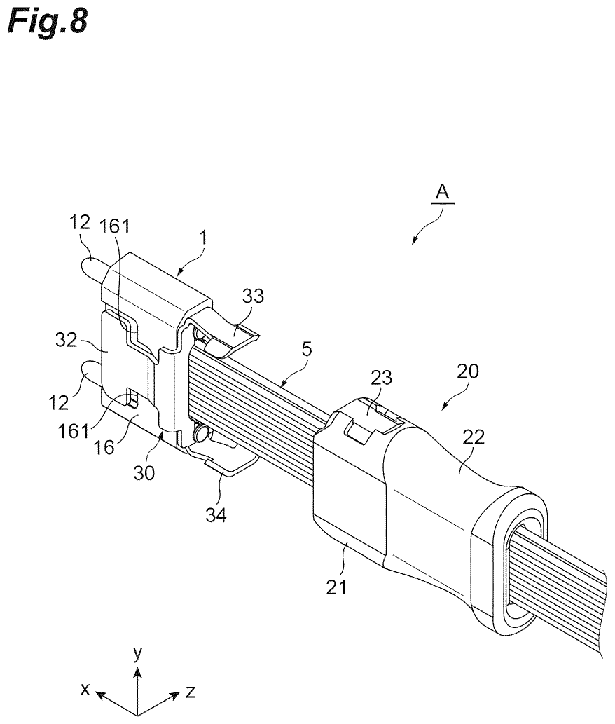

The connecting portion 30 is disposed between the ferrule 1 and the grip portion 20 in the x-direction, and connects the ferrule 1 and the grip portion 20. The material of a member constituting the connecting portion 30 is, for example, metal. The connecting portion 30 is formed, for example, by sheet metal working. The connecting portion 30 includes an engaging portion 31 (first engaging portion), an engaging portion 32 (second engaging portion), an engaging portion 33 (third engaging portion), an engaging portion 34 (fourth engaging portion), and a main body portion 38. The main body portion 38 is a plate-shaped portion extending along a plane intersecting the x-direction. The main body portion 38 is disposed on the rear end surface 10 of the ferrule 1. The main body portion 38 has a fiber insertion hole 35. The optical fiber group 5 is inserted into the fiber insertion hole 35. The main body portion 38 further has guide pin holding holes 36 and 37. FIG. 8 is a perspective view showing a state where the connecting portion 30 is attached to the ferrule 1. As shown in FIGS. 6 and 8, the guide pin holding holes 36 and 37 are fitted to the respective end portions of the two guide pins 12 to hold the end portions.

The engaging portion 31 protrudes forward from the main body portion 38 in the x-direction, and is disposed on the main surface 14 of the ferrule 1. The engaging portion 31 engages with the ferrule 1 on the main surface 14. Specifically, the engaging portion 31 has a planar shape such as a T-shape having an axis extending in the x-direction when viewed in the z-direction. Then, a portion of the T-shape which extends in the y-direction engages with the pair of steps 141 formed on the main surface 14. The engaging portion 32 protrudes forward from the main body portion 38 in the x-direction, and is disposed on the main surface 16 of the ferrule 1. That is, the engaging portion 32 interposes the ferrule 1 between the engaging portion 32 and the engaging portion 31. The engaging portion 32 engages with the ferrule 1 on the main surface 16. Specifically, the engaging portion 32 has a planar shape such as a T-shape having an axis extending in the x-direction when viewed in the z-direction. Then, a portion of the T-shape which extends in the y-direction engages with the pair of steps 161 (only one is shown in FIG. 6) formed on the main surface 16. In this way, the ferrule 1 is fixed to the connecting portion 30 by the engaging portions 31 and 32.

The engaging portion 33 protrudes rearward from the main body portion 38 in the x-direction, and is disposed on the side surface 25 of the grip portion 20. The engaging portion 33 engages with the grip portion 20 on the side surface 25. Specifically, the engaging portion 33 has a planar shape such as a T-shape having an axis extending in the x-direction when viewed in the y-direction. Then, the engaging portion 33 is accommodated in the recess 23 formed in the side surface 25. A portion of the T-shape which extends in the z-direction engages with the edge of the recess 23, so that the engaging portion 33 engages with the grip portion 20. The portion of the engaging portion 33 which extends in the z-direction may be curved or bent along the curved side surface 25. The engaging portion 34 protrudes rearward from the main body portion 38 in the x-direction, and is disposed on the side surface 26 of the grip portion 20. The engaging portion 34 engages with the grip portion 20 on the side surface 26. Specifically, the engaging portion 34 has a planar shape such as a T-shape having an axis extending in the x-direction when viewed in the y-direction. Then, the engaging portion 34 is accommodated in the recess (not shown) formed in the side surface 26. A portion of the T-shape which extends in the z-direction engages with the edge of the recess, so that the engaging portion 34 engages with the grip portion 20. The portion of the engaging portion 34 which extends in the z-direction may be curved or bent along the curved side surface 26. In this way, the grip portion 20 is fixed to the connecting portion 30 by the engaging portions 33 and 34.

Effects obtained by the optical connector A of the present embodiment described above will be described. In the optical connector A, a spacing between the side surface 13 and the side surface 15 defines a maximum width of the ferrule 1. For example, in a typical optical connector such as the optical connector C shown in FIGS. 1 to 4, at least a part of each of the side surfaces of a ferrule is covered by a housing. Therefore, portions of the housing that are provided on the side surfaces define a maximum width of the optical connector, and the maximum width of the optical connector is greater than a maximum width of the ferrule. In contrast, in the optical connector A of the present embodiment, the engaging portion 31 engages with the ferrule 1 on the main surface 14 of the ferrule 1, and the engaging portion 32 engages with the ferrule 1 on the main surface 16 of the ferrule 1, so that the ferrule 1 is fixed to the grip portion 20 via the connecting portion 30. Then, the entirety of the side surface 13 and the side surface 15 is exposed. Accordingly, the side surface 13 and the side surface 15 are not covered by a housing or the like, and the spacing between the side surface 13 and the side surface 15, that is, the maximum width of the ferrule 1 can be set to the maximum width of the optical connector. Therefore, the width of the optical connector A can be reduced, and the optical connector A can be miniaturized.

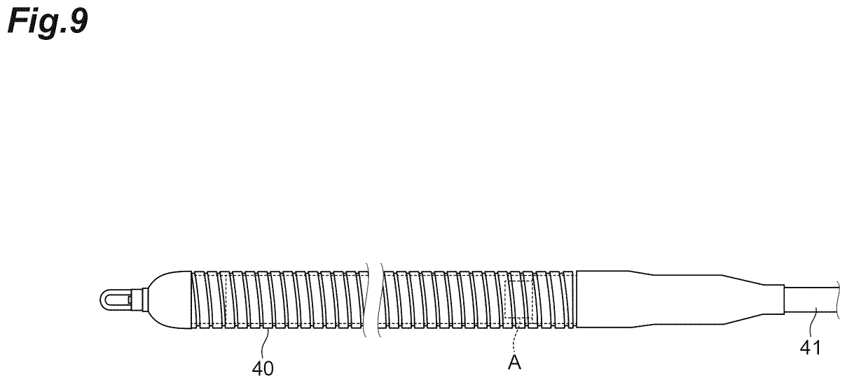

FIG. 9 is a side view showing a protective tube 40 having a cylindrical shape that is attached to a tip of an optical cable 41. The optical connector A may be accommodated in, for example, such a protective tube 40. For the sake of miniaturization, in recent years, the inner diameter of the protective tube 40 has become smaller. When the width of the optical connector A does not have sufficient clearance for the inner diameter of the protective tube 40, it is difficult to accommodate the optical connector A in the protective tube 40. According to the optical connector A of the present embodiment, since the width of the optical connector A can be reduced, the optical connector A is easily accommodated in the protective tube 40.

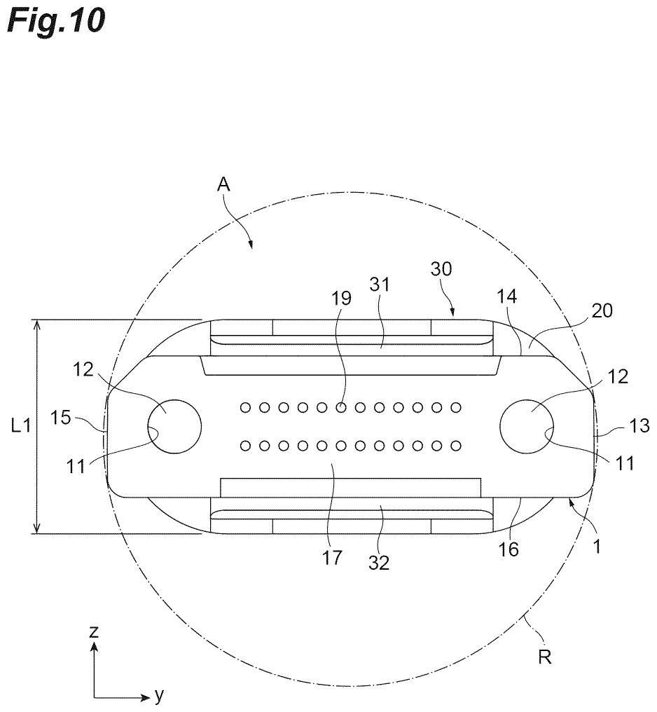

FIG. 10 is a front view of the optical connector A when viewed in the x-direction. In the optical connector A of the present embodiment, when viewed in the x-direction, the grip portion 20 and the connecting portion 30 are contained within a circumscribed circle R of the ferrule 1. A diameter of the circumscribed circle R is, for example, 5.4 mm or more and 7.8 mm or less, and in one example, the diameter is 6.5 mm. A width L1 of the grip portion 20 in the z-direction, that is, the maximum width of the optical connector A in the z-direction is, for example, 1.5 mm or more and 3.5 mm or less, and in one example, the width L1 is 2.8 mm.

In this way, when viewed in the x-direction, the grip portion 20 and the connecting portion 30 may be contained within the circumscribed circle R of the ferrule 1. In this case, the width of the optical connector A in any direction in a plane perpendicular to the x-direction is equal to or less than the maximum width of the ferrule 1. Therefore, the optical connector A is easily accommodated in the protective tube 40 having a cylindrical shape.

As in the present embodiment, the connecting portion 30 may hold the two guide pins 12. In this way, the connecting portion 30 may serve as a portion for holding the guide pins 12, that is, a guide pin keeper. In this case, compared to when a guide pin keeper is provided separately, the number of components can be reduced.

As in the present embodiment, the member constituting the grip portion 20 may be made of resin, and the member constituting the connecting portion 30 may be made of metal. By using resin as the material of the member constituting the grip portion 20, the weight of the optical connector A can be reduced. In addition, by using metal as the material of the member constituting the connecting portion 30, the strength of the connecting portion 30 can be improved.

As in the present embodiment, the grip portion 20 may have the side surface 25 and the side surface 26 that intersect the y-direction while facing away from each other with the plurality of optical fibers 4 interposed therebetween. The connecting portion 30 may include the engaging portion 33 that engages with the grip portion 20 on the side surface 25, and the engaging portion 34 that engages with the grip portion 20 on the side surface 26, and the grip portion 20 may be fixed to the connecting portion 30 by the engaging portion 33 and the engaging portion 34. In this case, in the connecting portion 30, a direction in which the engaging portion 31 and the engaging portion 32 are aligned (z-direction) and a direction in which the engaging portion 33 and the engaging portion 34 are aligned (y-direction) can be set different from each other. Therefore, the connecting portion 30 can be easily formed, for example, by forming the connecting portion 30 from a single metal sheet using sheet metal working.

In the optical connection structure 100 of the present embodiment, when the optical connector A is fitted to the sub-adapter D, the optical connector A is removed from the protective tube 40. Then, after the optical connector A is fitted to the sub-adapter D, the optical connector A becomes integrated with the sub-adapter D, and when the optical connector A is removed from the optical adapter B, the latch portions 91 of the sub-adapter D are released. According to such an optical connection structure 100, the optical connector A can be detachably fixed to the optical adapter B.

### First Modification

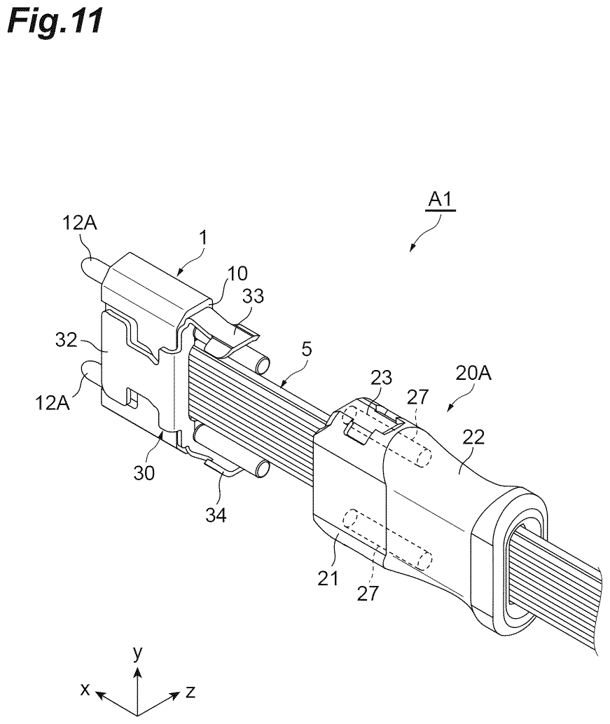

FIG. 11 is a perspective view showing an optical connector Al according to a first modification, and shows a state before a grip portion 20A is attached to the connecting portion 30. The optical connector Al of the present modification differs from the optical connector A of the embodiment in the following points, but is the same in other points. As shown in FIG. 11, the optical connector Al of the present modification includes two guide pins 12A instead of the two guide pins 12 of the embodiment. The guide pins 12A extend longer in the x-direction than the guide pins 12. Then, the guide pins 12A extend rearward from the rear end surface 10 in the x-direction. The optical connector Al includes the grip portion 20A instead of the grip portion 20. The grip portion 20A differs from the grip portion 20 in that the grip portion 20A has two guide pin holes 27 (second guide pin holes) communicating with the two respective guide pin holes 11 of the ferrule 1, but is the same as the grip portion 20 in other points. The two guide pins 12A are inserted from the two respective guide pin holes 11 of the ferrule 1 to the two respective guide pin holes 27 of the grip portion 20A. According to the present modification, the connection between the ferrule 1 and the grip portion 20A is further strengthened through the two guide pins 12A.

### Second Modification

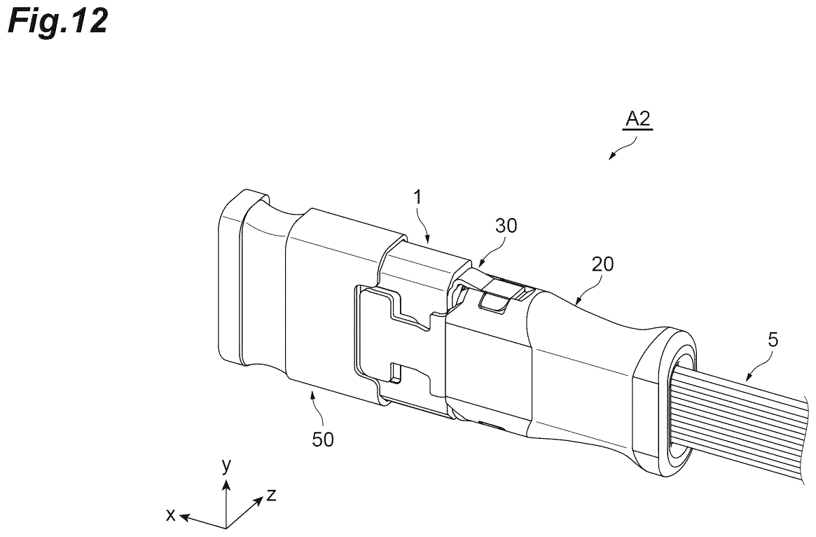

FIG. 12 is a perspective view showing an optical connector A2 according to a second modification. The optical connector A2 further includes a cap 50 in addition to the configuration of the optical connector A of the embodiment. The cap 50 covers the front end surface 17 of the ferrule 1 when the optical connector A2 is not connected, and is removed from the ferrule 1 when the optical connector A2 is connected.

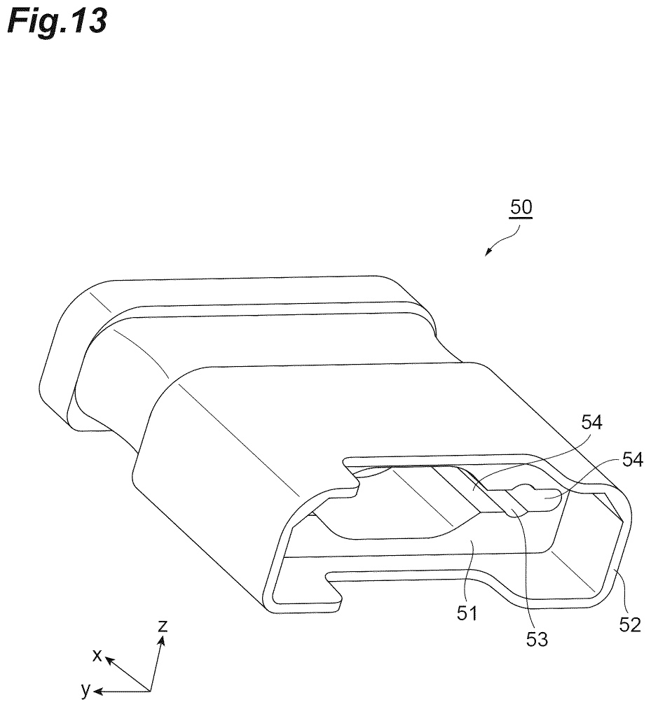

FIG. 13 is a perspective view showing the appearance of the cap 50. The cap 50 has a substantially rectangular shape when viewed in the x-direction, and has an end surface 51 that faces or abuts against the front end surface 17 of the ferrule 1. The end surface 51 extends along a plane intersecting the x-direction. The cap 50 protrudes rearward from a peripheral edge portion of the end surface 51 in the x-direction, and includes a side wall 52 surrounding the end surface 51. The side wall 52 is in contact with the side surfaces 13 and 15 and the main surfaces 14 and 16 of the ferrule 1, and covers portions of the side surfaces 13 and 15 and the main surfaces 14 and 16, the portions being closer to the front end surface 17. The cap 50 has two guide pin holes 53 (third guide pin holes, only one of which is shown in FIG. 13) extending forward from the end surface 51 in the x-direction. The two guide pin holes 53 communicate with the two respective guide pin holes 11 of the ferrule 1, and the two respective guide pins 12 (or the two respective guide pins 12A) are inserted into the two guide pin holes 53. Gaps 54 having a slit shape that extend in the x-direction and the y-direction are formed on both sides of the guide pin holes 53 in the y-direction. In a state where the guide pins 12 (or the guide pins 12A) are not inserted, an inner diameter of each of the guide pin holes 53 is slightly smaller than a diameter of the guide pins 12 (or the guide pins 12A). Accordingly, when the guide pins 12 (or the guide pins 12A) are inserted into the guide pin holes 53, the guide pin holes 53 are elastically expanded, and the cap 50 is reliably attached to the ferrule 1 due to the elastic force thereof. In this way, the front end surface 17 of the ferrule 1, the vicinity of the front end surface 17, the front end portion of the optical fiber group 5 (the plurality of optical fibers 4) exposed at the front end surface 17, and the guide pins 12 exposed from the front end surface 17 can be protected.

According to the present modification, since the cap 50 is supported by the two guide pins 12 (or the two guide pins 12A), the side wall 52 that covers the side surfaces 13 and 15 and the main surfaces 14 and 16 can be made thinner compared to when the cap 50 is supported only by the side surfaces 13 and 15 and the main surfaces 14 and 16 of the ferrule 1. Therefore, even in a state where the cap 50 is installed, the optical connector A2 can be miniaturized by reducing the width of the optical connector A2.

The optical connector and the optical connection structure according to the present disclosure are not limited to the embodiment described above, and can be modified in other various forms. For example, the embodiment and the modifications described above may be combined together depending on the required purpose and effects. In the embodiment, the connecting portion 30 holds the two guide pins 12; however, the optical connector may further include a member separate from the connecting portion 30 in order to hold the guide pins 12. In the embodiment, an example in which the member constituting the grip portion 20 is made of resin and the member constituting the connecting portion 30 is made of metal has been provided; however, the constituent materials of the grip portion 20 and the connecting portion 30 are not limited thereto.

### REFERENCE SIGNS LIST

1: ferrule, 1C: mating ferrule, 4, 6: optical fiber, 5, 7: optical fiber group, 10: rear end surface, 11, 27: guide pin hole, 12, 12A: guide pin, 13, 15: side surface, 14, 16: main surface, 17: front end surface, 19: fiber hole, 20, 20A: grip portion, 21: front portion, 22: rear portion, 23: recess, 24: through-hole, 25, 26: side surface, 30: connecting portion, 31, 32, 33, 34: engaging portion, 35: fiber insertion hole, 36, 37: guide pin holding hole, 38: main body portion, 40: protective tube, 41: optical cable, 50: cap, 51: end surface, 52: side wall, 53: guide pin hole, 54: gap, 91: latch portion, 92: fitting hole, 100: optical connection structure, 101: opening portion, 141, 161: step, A, A1, A2, C: optical connector, B: optical adapter, D: sub-adapter, L1: width, R: circumscribed circle.

1. An optical connector, comprising:
a plurality of optical fibers extending rearward along a first direction;
a ferrule that holds front end portions of the plurality of optical fibers;
a grip portion provided on an outer periphery of the plurality of optical fibers and disposed rearward of the ferrule; and
a connecting portion disposed between the ferrule and the grip portion and connecting the ferrule and the grip portion,
wherein the ferrule has a front end surface facing a mating ferrule in the first direction, a rear end surface facing away from the front end surface, a first side surface and a second side surface that intersect a second direction, which is a width direction of the ferrule, while facing away from each other with the plurality of optical fibers interposed between the first side surface and the second side surface, and that connect the front end surface and the rear end surface, and a first main surface and a second main surface that intersect a third direction, which is a thickness direction of the ferrule, while facing away from each other with the plurality of optical fibers interposed between the first main surface and the second main surface, and that connect the front end surface and the rear end surface,
the connecting portion includes a first engaging portion that engages with the ferrule on the first main surface, and a second engaging portion that engages with the ferrule on the second main surface, and the ferrule is fixed to the connecting portion by the first engaging portion and the second engaging portion, and
an entirety of the first side surface and the second side surface is exposed.

2. The optical connector according to claim 1, further comprising:
a guide pin,
wherein the ferrule further has a first guide pin hole penetrating through the ferrule along the first direction,
the grip portion has a second guide pin hole communicating with the first guide pin hole, and
the guide pin is inserted so as to extend from the first guide pin hole to the second guide pin hole.

3. The optical connector according to claim 1, further comprising:
a guide pin,
wherein the ferrule further has a first guide pin hole penetrating through the ferrule along the first direction,
the guide pin is inserted into the first guide pin hole, and
the connecting portion holds the guide pin.

4. The optical connector according to claim 1, further comprising:
a guide pin; and
a cap that covers the front end surface of the ferrule,
wherein the ferrule further has a first guide pin hole in the front end surface,
the guide pin is inserted into the first guide pin hole, and
the cap has a third guide pin hole which communicates with the first guide pin hole and into which the guide pin is inserted, and the cap is fixed to the ferrule by inserting the guide pin into the third guide pin hole.

5. The optical connector according to claim 1,
wherein the grip portion and the connecting portion are configured to be contained within a circumscribed circle of the ferrule when viewed in the first direction.

6. The optical connector according to claim 1,
wherein a member constituting the grip portion is made of resin, and a member constituting the connecting portion is made of metal.

7. The optical connector according to claim 1,
wherein the grip portion has a third side surface and a fourth side surface that intersect the second direction while facing away from each other with the plurality of optical fibers interposed between the third side surface and the fourth side surface, and
the connecting portion includes a third engaging portion that engages with the grip portion on the third side surface, and a fourth engaging portion that engages with the grip portion on the fourth side surface, and the grip portion is fixed to the connecting portion by the third engaging portion and the fourth engaging portion.

8. An optical connection structure, comprising:
the optical connector according to claim 1; and
a sub-adapter,
wherein the sub-adapter includes a latch portion that locks onto an optical adapter to detachably fix the sub-adapter to the optical adapter, and a fitting hole that is fitted to the optical connector, and
the optical connector is held by the sub-adapter by being fitted into the fitting hole of the sub-adapter.
